(19) United States
(12) Patent Application Publication
(10) Pub. No.: US 2012/0186378 A1
(43) Pub. Date: Jul. 26, 2012

(54) Device for pressing a transfer element

(76) Inventor: Helmut Bareis, Eschach (DE)

(21) Appl. No.: 13/385,055

(22) Filed: Jan. 31, 2012

Related U.S. Application Data
(63) Continuation of application No. PCT/EP2010/060940, filed on Jul. 28, 2010.

(30) Foreign Application Priority Data
Aug. 10, 2009 (DE) 10 2009 028 380.3

(51) Int. Cl. F16H 35/06

(52) U.S. Cl. 74/396

(57) ABSTRACT

Described is a device for pressing a first transmission element onto a second transmission element engaging with the first transmission element, in particular for a steering system of a motor vehicle, comprising a pressure piece which can be loaded in the direction of the first transmission element and is displaceably guided in a housing. The devices known from the prior art can cause undesirable noise during driving operations. The device according to the invention thus comprises an adjustment unit for minimizing play occurring between the first transmission element and the second transmission element.

This is a Continuation of U.S. National Stage of PCT/EP2010/060940 filed July 28, 2010.

### BACKGROUND OF THE INVENTION

The invention relates to a device for pressing a first transmission element onto a second transmission element engaging with the first transmission element, in particular for a steering system of a motor vehicle, comprising a pressure piece which can be loaded in the direction of the first transmission element and is displaceably guided in a housing.

A device of the type in question is described in DE 102 30 600 B4. This device is provided with a spring unit, which presses the pressure piece against a worm. The worm can thus be optimally pressed against a worm wheel, whereby as little play and as little wear as possible are created between the worm and the worm wheel. During driving operations of the motor vehicle, however, the worm is repeatedly pressed against the pressure piece, so that the spring unit strikes against a housing, which can generate undesirable noise.

### SUMMARY OF THE INVENTION

It is therefore the object of the invention to improve a device of the type mentioned above to the effect that undesirable noise is considerably reduced.

The object is achieved by the invention, by a device of the type mentioned above, in which, according to the invention, an adjustment unit for minimizing play occurring between the first transmission element and the second transmission element is provided. The play between the first transmission element and the second transmission element can thus be reduced to a permissible minimum. Consequently, undesirable noise is also clearly minimized. Minimal play, however, is useful so as to compensate for possible out-of-roundness on the transmission elements and potential thermal expansion affecting the operation of the transmission elements. The first transmission element is preferably a worm and the second transmission element is preferably a worm wheel. However, in principle, the two transmission elements can also be differing types of gear wheels.

The adjustment unit can comprise two adjusting disks that can be rotated relative to one another and are seated against one another on contact surfaces, wherein the contact surfaces comprise at least two oblique surface segments. By rotating the two adjusting disks relative to one another, and because of the oblique surface segments, the overall thickness of the two adjusting disks can be varied so as to reduce the play between the two transmission elements when it has become too large. In general, the common overall thickness of the adjusting disks is increased for this purpose. Because the oblique surface segments preferably have as small an angle of inclination as possible, turning back the adjusting disks, which would result in larger play, is precluded.

A torsion spring can be disposed between the two adjusting disks so as to be able to automatically rotate the two adjusting disks that can be rotated relative to one another when the play increases.

A spring washer between the pressure piece and the adjustment unit allows the pressure piece to move back and forth, the movement corresponding to the magnitude of the minimally permissible play.

If the adjustment unit comprises a projection and the pressure piece comprises a recess, or the pressure piece comprises a projection and the adjustment unit comprises a projection, in the region of the spring washer, the projection creates the play that is required to compensate for the aforementioned out-of-roundness and thermal expansion. The play between the two transmission elements is thus assured exclusively by the structural design of the projection and the recess. The play thus does not need complex adjustment by way of screws or other means. The recess allows the spring washer the spring travel that it requires for the back and forth movement of the pressure piece.

The projection should be slightly larger than the permissible play between the two transmission elements, because the adjustment unit produces little spring travel of the spring washer, in particular when it comprises the two adjusting disks with the torsion spring. This spring travel, which is almost impossible to avoid, can thus be compensated for when the projection is slightly larger than the permissible play.

The pressing surface between the pressure piece and the spring washer and/or the pressing surface between the adjustment unit and the spring washer should be as large as possible, so as to be able to transmit the highest possible forces with the lowest possible surface pressure. As low a surface pressure as possible is particularly important, if the adjusting disks are to be produced from synthetic material.

The pressure piece can advantageously comprise a further recess for accommodating the spring washer. The additional recess can comprise a peripheral protruding edge that can be press-fit stemmed, so as to center the spring washer, without the spring washer being able to detach from the pressure piece.

The adjustment unit can have a recess in the edge region on the side located opposite of the pressure piece. If the adjustment unit comprises the two adjusting disks, the recess is provided in the edge region of the adjusting disk located opposite of the pressure piece. The recess is advantageously located opposite of the edge that can be press-fit stemmed. The recess thus forms a clearance, which prevents the adjustment unit from striking against the pressure piece when the pressure piece is moved toward the adjustment unit.

Because the forces to be absorbed by the spring washer are comparatively low, the washer can have at least one recess in the inner region. The recess can be a borehole or a slot or the like. Because of the recess, the spring washer can be produced from slightly thicker material. In terms of flatness and tolerances, a slightly thicker spring washer can be better produced than a very thin spring washer.

The device according to the invention exhibits particularly good results when the spring washer has a thickness between 0.2 millimeters and 0.4 millimeters.

The spring washer can be a stamped part, which can be produced cost-effectively, notably at high quantities.

So as to simplify the installation of the device according to the invention, the two adjusting disks can be pressed against each other for this purpose, for example by a removable screw. Instead of the screw, another connecting element or tool can be used as an aid.

After installation is completed, the device can be secured on a gearbox housing, for example by press-fit stemming, gluing or the like.

The invention further relates to a steering system, and more particularly to an electrical steering system of a motor vehicle.

An exemplary embodiment of the device according to the invention will be described hereafter in more detail based on the accompanying drawings.

### BRIEF DESCRIPTION OF THE DRAWINGS

FIG. 1 is a general view of an electrical steering system of a motor vehicle;

FIG. 2 is a sectional view of the device and a gearbox;

FIG. 3 is a sectional view of the device; and

FIG. 4 is a perspective view of an adjusting disk.

### DESCRIPTION OF THE PREFERRED EMBODIMENTS

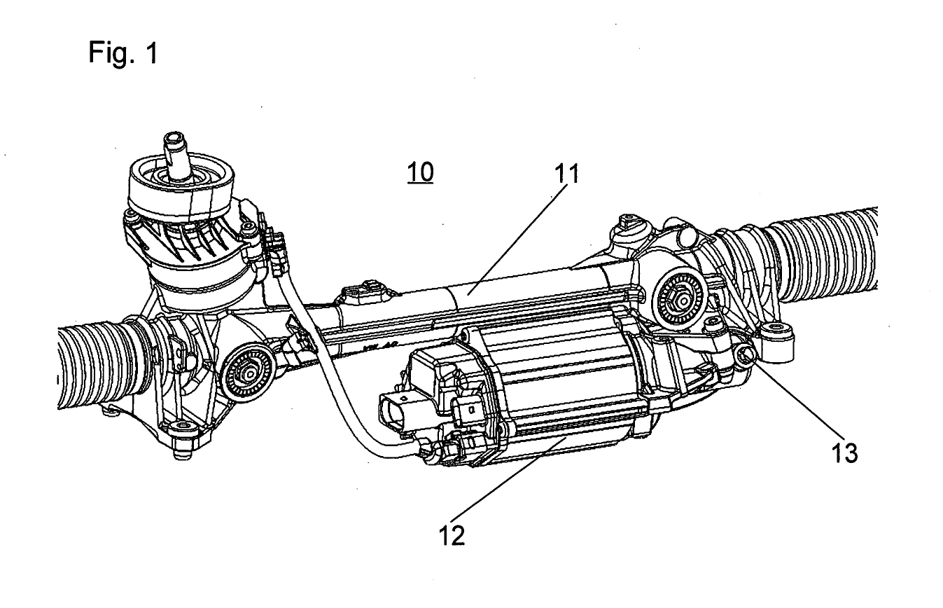

FIG. 1 shows an electrical steering system 10, comprising a housing region 11, behind which a steering rack is hidden, a housing region 12, behind which an electric motor is mounted, and a device 13 for pressing on a transmission element, which is not shown in detail here.

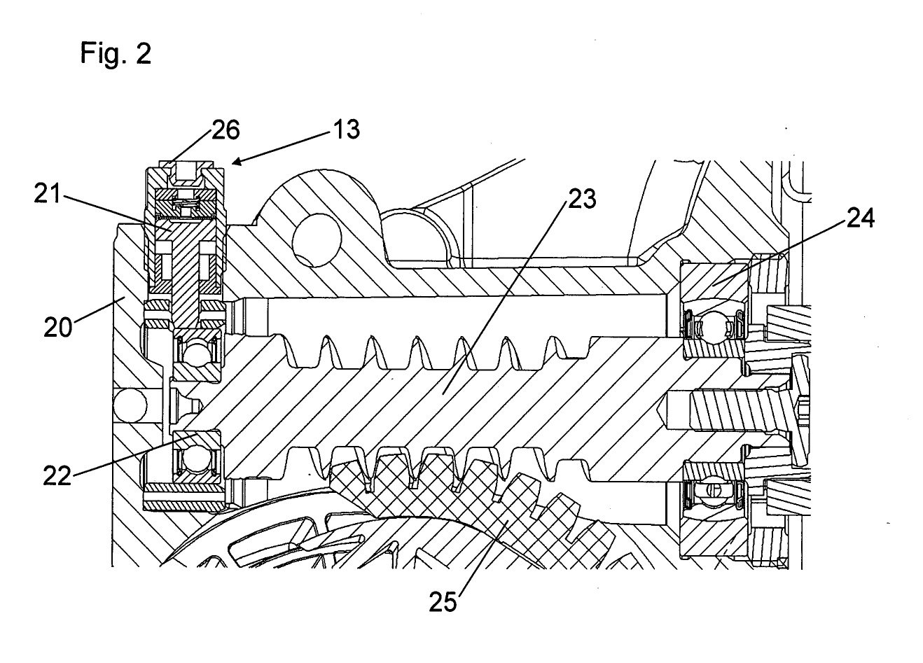

The device 13 is screwed into a gearbox housing 20 (see FIG. 2). A pressure piece 21, which is provided in the device 13, presses onto a bearing 22, which at one end is disposed on a transmission element 23 designed as a worm. At the other end, a bearing 24 is provided on the transmission element 23, the bearing being designed so as to allow the transmission element 23 to perform pivoting movements. The bearing 22 can consequently carry out smaller movements in the vertical direction.

The transmission element 23 designed as a worm engages with a transmission element 25 designed as a worm wheel. The device 13 consequently presses the transmission element 23 against the transmission element 25, whereby these can optimally engage with one another.

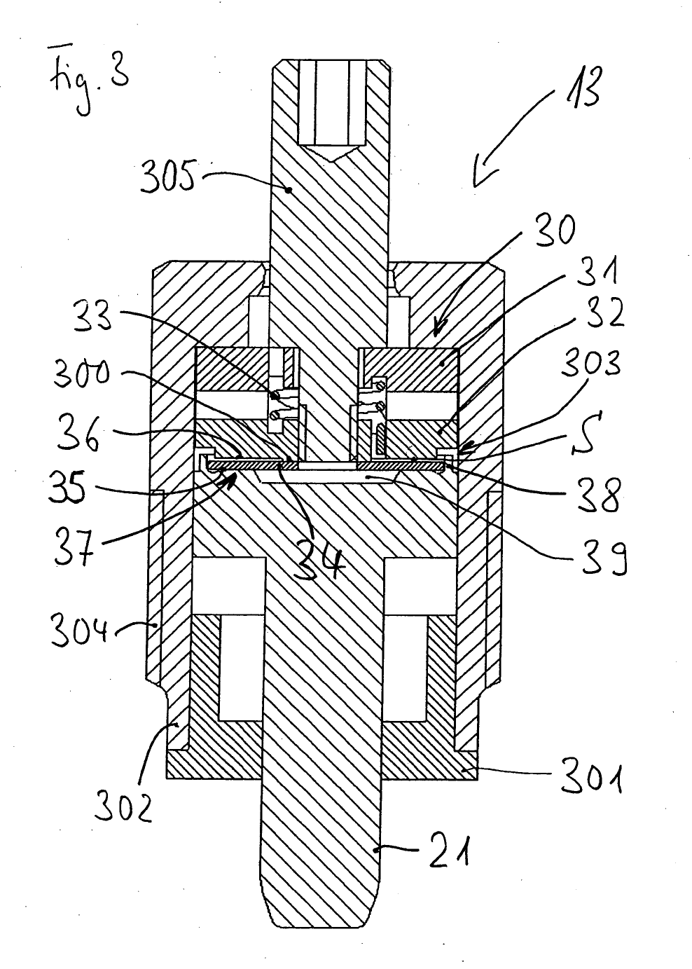

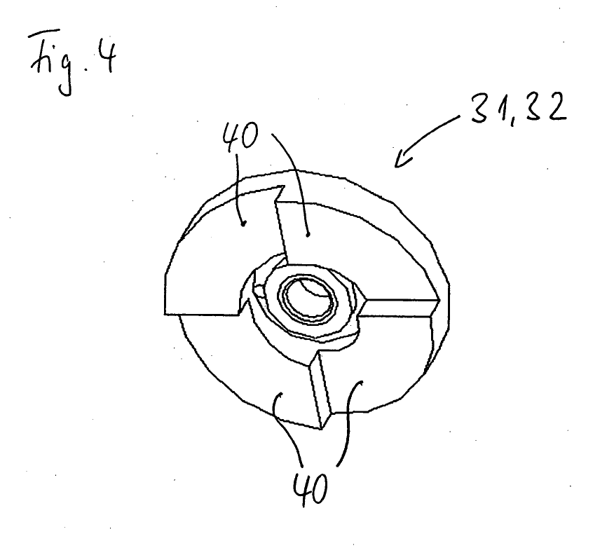

The device 13 is equipped with an adjustment unit 30 (see FIG. 3). The adjustment unit 30 comprises two adjusting disks 31 and 32. The adjusting disks 31 and 32 are provided with oblique surface segments 40 on the contact surface at which they are seated against one another (see FIG. 4). A torsion spring 33 is installed between the adjusting disks 31 and 32 (see FIG. 3), wherein the spring can rotate the two adjusting disks 31 and 32 relative to one another.

A spring washer 34 is disposed between the adjustment unit 30 and the pressure piece 21, or between the adjusting disk 32 and the pressure piece 21. The one side of the spring washer is seated against the pressure piece 21 on an annular pressing surface 35. The other side is seated against the adjusting disk 32 on an annular pressing surface 36. The pressing surfaces 35 and 36 should be as large as possible so as to be able to transmit the highest possible forces at the lowest possible surface pressure. The spring washer 34 is introduced in a recess 37 which is surrounded by an edge 38 that can be press-fit stemmed. A peripheral recess 303 is provided opposite the edge 38. This recess prevents the adjustment unit 30 from striking against the pressure piece 21 when it is moved toward the adjustment unit 30.

In the region of the spring washer 34, the pressure piece 21 comprises a further recess 39 and the adjusting disk 32 comprises a projection 300.

The projection 300, or a distance S, between the projection 300 and the pressing surface 36, establishes the minimally permissible play between the two transmission elements 23 and 25.

If during driving operations of the motor vehicle the pressure piece 21 is pressed against the adjustment unit 30 due to out-of-roundness of the transmission elements 23 and 25, the spring washer 34 deflects into the recess 39 because of the projection 300.

As a result of wear and other changes that occur over time, the play between the two transmission elements 23 and 25 may increase. The torsion spring 33 then rotates the two adjusting disks 31 and 32 with respect to one another so that the common overall thickness thereof increases and the play is reduced to the minimally permissible value established by the distance S. Because the oblique surface segments 40 have as small an angle of inclination as possible, the pressure piece 21 is not able to rotate the two adjusting disks 31 and 32 back in a way that would decrease the common overall thickness and once again increase the play between the two transmission elements 23 and 25.

The pressure piece 21 is displaceably guided in the axial direction by a guide element 301 and a housing 302.

During installation, the device 13 is screwed into the gearbox housing 20 (see FIG. 2) by means of a thread 304. For this purpose, a hexagon, which is provided opposite the thread 304, and which is not shown, is incorporated in the housing 302 (see FIG. 3). The device 13 is screwed so tightly into the gearbox housing 20 that the spring washer is seated against the pressing surface 36. The device 13 is then rotated by a certain angle in the opposite direction, wherein this angle corresponds to travel in the axial direction which satisfies at least the minimal permissible play. If the travel in the axial direction is greater than the minimal permissible play, the two adjusting disks 31 and 32 can compensate for this deviation after the adjustment unit 30 has been activated. After the device 13 has reached the final position, it can be secured, for example, by press-fit stemming, gluing or the like. Finally, the screw 305 is removed, whereby the adjustment unit 30 is activated.

A plug 26 (see FIG. 2) closes an opening in which the screw 305 was introduced.

List of reference numerals

| | |
|---|---|
| 10 Electrical steering system | 34 Spring washer |
| 11 Housing region of steering rack | 35 Pressing surface |
| 12 Housing region of | 36 Pressing surface |
| electric motor | 37 Recess |
| 13 Device | 38 Edge |
| 20 Gearbox housing | 39 Recess |
| 21 Pressure piece | 40 Surface segments |
| 22 Bearing | 300 Projection |
| 23 Transmission element | 301 Guide element |
| 24 Bearing | 302 Housing |
| 25 Transmission element | 303 Recess |
| 26 Plug | 304 Thread |
| 30 Adjustment unit | 305 Screw |
| 31 Adjusting disk | S Distance |
| 32 Adjusting disk | |
| 33 Torsion spring | |

1. A device for an electrical steering system of a motor vehicle for pressing a worm onto a worm wheel engaging with the worm, comprising a pressure piece that can be loaded in the direction of the worm and is displaceably guided in a housing wherein the device comprises an adjustment unit for minimizing play occurring between the worm and the worm wheel.

2. The device according to claim 1, wherein the adjustment unit comprises two adjusting disks that can be rotated relative to one another and are seated against one another on contact surfaces, and the contact surfaces comprise at least two oblique surface segments.

3. The device according to claim 1, comprising a torsion spring that can be disposed between the two adjusting disks that can be rotated relative to one another.

4. A device according to claim 1, comprising a spring washer disposed between the adjustment unit and the pressure piece.

5. The device according to claim 4, wherein the adjustment unit comprises a projection and the pressure piece comprises a recess, or the pressure piece comprises a projection and the adjustment unit comprises a recess, in the region of the spring washer.

6. The device according to claim 5, wherein the projection is slightly larger than the permissible play between the worm and the worm wheel.

7. A device according to claim 4, wherein a pressing surface between the pressure piece and the spring washer and/or a pressing surface between the adjustment unit and the spring washer are as large as possible.

8. The device according to claim 4, wherein the pressure piece comprises a further recess for accommodating the spring washer.

9. The device according to claim 8, wherein the further recess comprises a peripheral protruding edge that can be press-fit stemmed.

10. A device according to claim 1, wherein the adjustment unit comprises a recess in the edge region on the side thereof opposite the pressure piece.

11. A device according to claim 4, wherein the spring washer has at least one recess in an inner region.

12. A device according to claim 4, wherein the spring washer has a thickness between 0.2 millimeters and 0.4 millimeters.

13. A device according to claim 4, wherein the spring washer is a stamped part.

14. A device according to that claim 2, wherein the two adjusting disks can be pressed against one another using a removal screw.

15. A device according to claim 1, wherein the device is securable on a gearbox housing.

16. (canceled)
